(19) United States
(12) Patent Application Publication
(10) Pub. No.: US 2022/0098044 A1
(43) Pub. Date: Mar. 31, 2022

(54) PASSIVATION OF FRESHLY MILLED SILICON

(71) Applicant: Nanostar, Inc., New Orleans, LA (US)

(72) Inventors: Jonathan Goodman, New Orleans, LA (US); Shiva Adireddy, Metairie, LA (US); Erin Perry, New Orleans, LA (US); Mariah Gewin, New Orleans, LA (US)

(21) Appl. No.: 17/365,073

(22) Filed: Jul. 1, 2021

Related U.S. Application Data
(60) Provisional application No. 63/024,035, filed on May 13, 2020.

(51) Int. Cl. C01B 33/021

(52) U.S. Cl. CPC C01B 33/021; B82Y 30/00

(57) ABSTRACT

Herewith is described a process to produce stable, non-pyrophoric silicon nanocrystals as an isolatable powder. The process includes comminuting a silicon feed in a solvent thereby forming a silicon nanoparticle slurry, admixing a dry (water free) reagent with the silicon nanoparticle slurry thereby forming a SiX-coated silicon nanoparticle slurry. The reagent is, preferably, selected from an oxide source, a sulfide source, or a carbide source; where the SiX-coated silicon nanoparticle includes a SiX coating on a silicon nanoparticle and the SiX coating is a silicon-oxide when the reagent is an oxide source, a silicon-sulfide when the reagent is a sulfide source, or a silicon-carbide when the reagent is a carbide source.

### CROSS REFERENCE TO RELATED APPLICATIONS

This application claims benefit to U.S. Provisional Application No. 63/024,035, filed on May 13, 2020, which is incorporated herein by reference in its entirety.

### FIELD OF THE INVENTION

This disclosure is directed to the passivation of pyrophoric silicon nanoparticles for use in lithium ion batteries.

### BACKGROUND

Lithium-ion (Li⁺) secondary or rechargeable batteries are now the most widely used secondary battery systems for portable electronic devices. However, the growth in power and energy densities for lithium ion battery technology has stagnated in recent years as materials that exhibit both high capacities and safe, stable cycling have been slow to be developed. Much of the current research effort for the next generation of higher energy capacity materials has revolved around using small or nanoparticulate active material bound together with conductive agents and carbonaceous binders.

There is a current and growing need for higher power and energy density battery systems. The power requirements for small scale devices such as microelectromechanical systems (MEMS), small dimensional sensor systems, and integrated on-chip microelectronics exceed the power densities of current Li⁺ based energy storage systems. Power densities of at least 1 J/mm² are desired for effective function for such systems, and current energy densities for Li⁺ thin film battery systems are about 0.02 J/mm². Three dimensional architectures for battery design can improve the areal power density of Li⁺ secondary batteries by packing more active material per unit area without employing thicker films that are subject to excessive cycling fatigue. Three-dimensional Lithium-ion battery architectures also increase lithium ion diffusion by maximizing the surface area to volume ratio and by reducing diffusion lengths.

The current state-of-the-art for anode electrodes in lithium ion batteries includes the use of high surface area carbon materials. However, the capacity of any graphitic carbon, carbon black, or other carbonaceous material is limited to a theoretical maximum of 372 mAh/g and about 300 mAh/g in practice because carbon electrodes are usually formed of carbon particles mixed with a polymeric binder pressed together to form a bulk electrode. To store charge, Li⁺ intercalates between the planes of sp² carbon atoms and this C—Li⁺—C moiety is reduced. In addition, the maximum number of Li⁺ that can be stored is one per every six carbon atoms (LiC₆). While the capacity of graphitic carbon is not terribly high, the intercalation process preserves the crystal structure of the graphitic carbon, and so cycle life can be very good.

A more recent and promising option for anode materials is silicon (Si). In contrast to the intercalative charge storage observed in graphite, Si forms an alloy with lithium. Silicon-based negative electrodes are attractive because their high theoretical specific capacity of about 4200 mAh/g, which far exceeds than that of carbon, and is second only to pure Li metal. This high capacity comes from the conversion of the Si electrode to a lithium silicide which at its maximum capacity has a formula of Li₂₂Si₆, storing over 25 times more Li per atom than carbon. The large influx of atoms upon alloying, however, causes volumetric expansion of the Si electrode of over 400%. This expansion causes strain in the electrode, and this strain is released by formation of fractures and eventual electrode failure. Repeated cycling between LiₓSi_{y} and Si thus causes crumbling of the electrode and loss of interconnectivity of the material. For example, 1 μm thick Si film anodes have displayed short cyclability windows, with a precipitously capacity drop after only 20 cycles.

Commonly, silicon nanocrystals are used for lithium-ion batteries and are prepared by gas phase synthesis (e.g., CVD), conventional solution-based nanocrystal growth (e.g., utilizing surface passivation agents and an Oswald ripening mechanism), jet milling, or mechanical comminution. Of these methods, mechanical comminution is the most industrially scalable. Notably, the comminution of silicon in aliphatic or aromatic solvents is known to produce pyrophoric silicon powders due to the rapid reaction of silicon with water (including atmospheric water). The pyrophoricity of the silicon powders is an industrial hazard and is an instability that is incompatible with the large-scale incorporation of silicon into lithium ion battery systems. Accordingly, there is a need for the controlled production of nanoscale silicon powders that are shelf stable and are not industrial hazards.

### SUMMARY

Herewith is described a process that includes comminuting a silicon feed in a solvent thereby forming a silicon nanoparticle slurry; admixing a “dry” reagent with the silicon nanoparticle slurry thereby forming an SiX-coated silicon nanoparticle slurry; wherein the reagent is selected from an oxide source, a sulfide source, or a carbide source; wherein the SiX-coated silicon nanoparticle slurry includes a SiX-coated silicon nanoparticle in the solvent; wherein the SiX-coated silicon nanoparticle includes a SiX coating on a silicon nanoparticle; and wherein the SiX coating is a silicon-oxide when the reagent is an oxide source, a silicon-sulfide when the reagent is a sulfide source, or a silicon-carbide when the reagent is a carbide source.

### BRIEF DESCRIPTION OF THE FIGURES

For a more complete understanding of the disclosure, reference should be made to the following detailed description and accompanying drawing figures.

FIG. 1 is a schematic of one example of the process described herein.

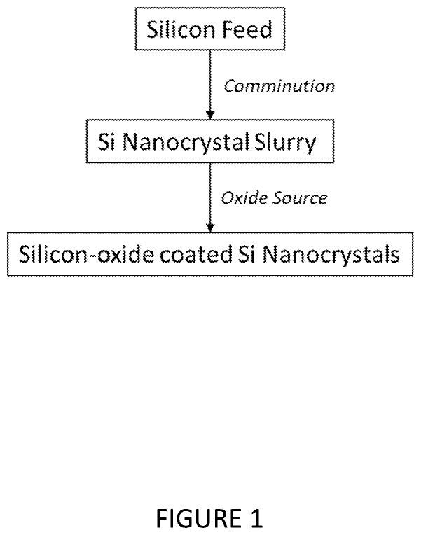

While specific examples are illustrated in the figures, with the understanding that the disclosure is intended to be illustrative, these examples are not intended to limit the disclosure described and illustrated herein.

### DETAILED DESCRIPTION

Objects, features, and advantages of the present disclosure will become apparent from the following detailed description. It should be understood, however, that the detailed description and the specific examples, while indicating specific examples of the disclosure, are given by way of illustration only, since various changes and modifications within the spirit and scope of the disclosure will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The comminution of a silicon feed provides a silicon product with a reactive surface. The newly formed, unpassivated silicon atoms that form the surface of the comminuted silicon typically react with any form of moisture available to them. When the comminution provides silicon nanoparticles, the silicon nanoparticles show pyrophoric behaviors. Herewith is provide a process that passivates the surface of the comminuted silicon thereby providing a stable, non-pyrophoric product with a controlled surface chemistry. In one instance, the process first includes comminuting a silicon feed in a solvent thereby forming a silicon nanoparticle slurry; and then includes admixing a dry reagent with the silicon nanoparticle slurry thereby forming a SiX-coated silicon nanoparticle slurry. In another instance, the process includes comminuting a silicon feed in a solvent thereby forming a silicon nanoparticle slurry, where the comminution of the silicon feed occurs in the presence of a dry reagent a SiX-coated silicon nanoparticle slurry.

The comminution of the silicon feed is the reduction of the silicon feed from one average particle size to a smaller average particle size, by crushing, grinding, cutting, vibrating, or other processes. In a preferable instance, the silicon feed is comminuted to an average particle size or an average diameter of about 50 to about 500 nm, about 50 to about 400 nm, about 50 to about 300 nm, about 50 to about 250 nm, or about 50 to about 200 nm. In another preferable instance, the comminution is a trituration of the silicon feed; is still a more preferable instance, the comminution is a levigation of the silicon feed.

The comminution of the silicon feed can include processing of the silicon feed in a comminution mill. In one example, the processing in the comminution mill can include recirculating the admixture through a milling volume. Preferably, the comminution mill is a recirculating bead mill. Examples of comminution mills include a Buhler Cenomic, a Buhler Macromedia, and a Netzsch KappaVita. In one example, the silicon feed is milled to a plurality of silicon nanocrystals with a total energy input between about 1,000 to about 15,000 kWhr/ton, about 1,500 to about 12,500 kWhr/ton, about 2,000 to about 10,000 kWhr/ton, or about 2,500 to about 7,500 kWhr/ton. In another example, the comminution mill is a bead mill adapted for operation in a one-pass mode.

As described herein, the reagent, admixed with the silicon nanoparticles, is preferably dry. That is, the reagent is, preferably, free of water, residual water, or traces of water. In a preferable instance, the concentration of water (vapor or otherwise) is less than 0.1%, 0.01%, or 0.001%. The method for drying the reagent is dependent on the amount, volume or mass, of the reagent utilized. For small volumes of a gas, the reagent can be passed through sulfuric acid (i.e., when the reagent is a gas), passed over activated sieves (gas or liquid), or passed over activated alumina (gas or liquid). Generally, the methods for drying the reagent are known in the art.

Herewith, the reagent is preferably an oxide source, a sulfide source, or a carbide source. In a preferable instance, the reagent consists of an oxide source, a sulfide source, or a carbide source and is free of water (i.e., undetectable amount of water as determined by standard methods and typically is less than 1 part per million by weight). As used herein, these materials provide an oxide, sulfide, or carbide, respectively, and result in the formation of a silicon oxide, silicon sulfide, or silicon carbide carried on the silicon nanoparticle. While the reagent is selected from an oxide source, a sulfide source, or a carbide source, the regent is preferably not an admixture of an oxide source with either of the sulfide source of the carbide source. Preferably through a metered chemical reaction, the reagent converts or reacts with the unpassivated silicon atoms that form the surface of the comminuted silicon in the silicon nanoparticle slurry and thereby provides the SiX-coated silicon nanoparticle slurry. The SiX-coated silicon nanoparticle slurry includes a SiX-coated silicon nanoparticle in the solvent where the SiX-coated silicon nanoparticle includes a SiX coating on a silicon nanoparticle. Notably, the SiX coating is a silicon-oxide when the reagent is an oxide source, a silicon-sulfide when the reagent is a sulfide source, or a silicon-carbide when the reagent is a carbide source.

While the SiX coating on the silicon nanoparticle can be a monolayer of the oxide, sulfide, or carbide, the SiX coating may have a thickness of about 0.1 nm or more, about 1 nm or more, about 100 nm or more. The SiX coating may have a thickness of about 5 μm or less, about 1 μm or less, or about 0.5 μm or less. Additionally, the SiX coating is, preferably, a conformal coating on the silicon nanoparticles. Preferably, the SiX coating does not significantly affect the average diameter of the nanoparticles, accordingly, the SiX-coated silicon nanoparticles preferably have an average diameter of about 50 to about 500 nm, about 50 to about 400 nm, about 50 to about 300 nm, about 50 to about 250 nm, or about 50 to about 200 nm.

In one instance, the reagent is an oxide source, where the oxide source can be oxygen (O₂), an N-oxide, sulfur trioxide, carbon dioxide, or a mixture thereof. Preferably, the oxide source is oxygen (O₂) which can be added neat or as a mixture in an additional gas, e.g. nitrogen or argon. In one example, the oxygen is added as a mixture that includes an oxygen percentage of about 5 vol. % to about 100 vol. %. Notably, the mixture can include oxygen below a lower flammability limit for the solvent, often between about 5 vol. % and about 15 vol. %. One particularly useful example includes dry air with an oxygen percentage of about 21 vol. %. In another particularly useful example, the oxygen is added neat (100%) or as an oxygen enhanced mixture (greater than 33 vol. %) to the slurry which is held under an inert atmosphere, e.g., nitrogen or argon. Notably, the oxygen can be added to a head space above the slurry and incorporated into the slurry by diffusion or vigorous mixing. Alternatively, the oxygen can be sparged through the slurry. In another preferably example, the oxide source is an N-oxide which can include but is not limited to pyridine N-oxide, lutidine N-oxide, picoline N-oxide, quinoline N-oxide, methylmorpholine N-oxide, trimethylamine n-oxide, and mixtures or derivatives thereof. The N-oxide can be added as a solid to the slurry or as a solution in a solvent that dissolves the N-oxide, or optionally as a slurry itself. Preferably, the N-oxide is selected from pyridine N-oxide and trimethylamine N-oxide. In another example, the oxide source may be a siloxane or a residue of a siloxane that can be added to the slurry. Residue with respect to an ingredient or reactant used to prepare the compounds or structures disclosed herein means that portion of the ingredient that remains in the compound or structures after inclusion as a result of the methods disclosed herein. In one particular example, the oxide source reacts with the silicon nanoparticle and provides a SiX coating has a formula of SiOₓ where x is about 0.5 to 2; about 0.5 to about 1.9, about 0.5 to about 1.8, about 0.5 to about 1.7, about 0.5 to about 1.6, or about 0.5 to about 1.5.

In another instance, the reagent is a sulfide source, where the sulfide source can be sulfur (elemental sulfur). While sulfur can exist as many allotropes, the reagent is preferably S₆, S₇, S₈, or mixtures thereof. In one instance, the sulfide source (sulfur) is added as a solution in carbon disulfide. In another instance, the sulfur is added as a solution in pyridine. In one particular example, the sulfide source reacts with the silicon nanoparticle and provides a SiX coating has a formula of SiSₓ where x is about 0.5 to 2; about 0.5 to about 1.9, about 0.5 to about 1.8, about 0.5 to about 1.7, about 0.5 to about 1.6, or about 0.5 to about 1.5.

In still another instance, the reagent is a carbide source, were the carbide source can be carbon. While carbon exists as many allotropes, the reagent is, preferably, amorphous carbon. In one example, the amorphous carbon is carbon black. In another example, the amorphous carbon is an active carbon. The carbide source is preferably added to the silicon nanocrystal slurry as a dry powder or as an amorphous carbon slurry. In one instance, the admixture of the reagent in the silicon nanocrystal slurry requires significant time and/or energy to complete the formation of the SiX coating, accordingly, the admixture can be heated to a temperature of about 30° C. to about 200° C. and/or optionally run through the comminution mill without affecting the size of the silicon nanocrystals but as a means of thoroughly mixing the reagent with the slurry. In one particular example, the carbide source reacts with the silicon nanoparticle and provides a SiX coating has a formula of SiCₓ where x is about 0.5 to 2; about 0.5 to about 1.9, about 0.5 to about 1.8, about 0.5 to about 1.7, about 0.5 to about 1.6, or about 0.5 to about 1.5.

The process can further includes comprising heating the SiX-coated silicon nanoparticle slurry or the SiX-coated nanoparticle. The heating of the slurry can include raising the temperature of the slurry to about 30° C. to the boiling point of the solvent. In some instances that temperature of the slurry can be increased above the boiling point of the solvent when the slurry is maintained under pressures in excess of 1 ATM. The temperature of the slurry is preferably heated to about 50° C. to the boiling point of the solvent. In one example, the solvent is removed from the SiX-coated silicon nanoparticle slurry by distillation at atmospheric pressure, e.g., at the normal boiling point of the solvent. In another example, the solvent is removed by vacuum distillation, thereby at a temperature below the normal boiling point of the solvent.

The heating of the SiX-coating silicon nanoparticle can anneal the SiX-coated silicon nanoparticle. That is, the process can include annealing the SiX-coated silicon nanoparticle. In one preferably instance, the annealing affects the crystal structure of the SiX coating but not the crystal structure of the silicon nanocrystal. That is, the annealing is preferably at a temperature below about 800° C., 700° C., 600° C., 500° C., 400° C. or 300° C. In one preferably instance, the SiX coating is a silicon-oxide, and the annealing step crystallizes the silicon-oxide on the silicon nanocrystal.

While the compositions and methods of this disclosure have been described in terms of preferred examples, it will be apparent to those of skill in the art that variations may be applied to the compositions and/or methods in the steps or in the sequence of steps of the method described herein without departing from the concept, spirit and scope of the disclosure. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the disclosure as defined by the appended claims.

What is claimed:

1. A process comprising:
comminuting a silicon feed in a solvent thereby forming a silicon nanoparticle slurry;
admixing a dry reagent with the silicon nanoparticle slurry thereby forming an SiX-coated silicon nanoparticle slurry;
wherein the dry reagent is selected from an oxide source, a sulfide source, or a carbide source; wherein the SiX-coated silicon nanoparticle slurry includes a SiX-coated silicon nanoparticle in the solvent; wherein the SiX-coated silicon nanoparticle includes a SiX coating on a silicon nanoparticle; and wherein the SiX coating is a silicon-oxide when the reagent is an oxide source, a silicon-sulfide when the reagent is a sulfide source, or a silicon-carbide when the reagent is a carbide source.

2. The process of claim 1, wherein the silicon feed is comminuted and then the dry reagent is mixed with the silicon nanoparticle slurry.

3. The process of claim 1, wherein the silicon feed is comminuted in the presence of the dry reagent.

4. The process of claim 1 further comprising heating the SiX-coated silicon nanoparticle slurry.

5. The process of claim 1 further comprising removing the solvent from the SiX-coated silicon nanoparticle slurry.

6. The process of claim 5 further comprising annealing the SiX-coated silicon nanoparticle.

7. The process of claim 6, wherein the SiX coating is a silicon-oxide, and wherein annealing crystallizes the silicon-oxide.

8. The process of claim 1, wherein the oxide source is oxygen.

9. The process of claim 1, wherein the oxide source is an N-oxide.

10. The process of claim 1, wherein the oxide source is selected from sulfur trioxide, carbon dioxide, or a mixture thereof.

11. The process of claim 1, wherein the sulfide source is sulfur.

12. The process of claim 1, wherein the carbide source is amorphous carbon.

13. The process of claim 1, wherein the SiX coating has a thickness of about 0.1 nm or more or about 0.05 μm or less.

14. The process of claim 13, wherein the SiX coating has a formula of SiOₓ where x is about 0.5 to 2; about 0.5 to about 1.9, about 0.5 to about 1.8, about 0.5 to about 1.7, about 0.5 to about 1.6, or about 0.5 to about 1.5.

15. The process of claim 13, wherein the SiX coating has a formula of SiSₓ where x is about 0.5 to 2; about 0.5 to about 1.9, about 0.5 to about 1.8, about 0.5 to about 1.7, about 0.5 to about 1.6, or about 0.5 to about 1.5.

16. The process of claim 13, wherein the SiX coating has a formula of SiCₓ where x is about 0.5 to 2; about 0.5 to about 1.9, about 0.5 to about 1.8, about 0.5 to about 1.7, about 0.5 to about 1.6, or about 0.5 to about 1.5.

17. The process of claim 13, wherein the SiX coating is derived from the oxide source, and wherein the oxide source includes a siloxane or a residue of a siloxane.

18. The process of claim 1, wherein the silicon nanoparticles and the SiX-coated silicon nanoparticles have an average diameter of about 50 to about 500 nm, about 50 to about 400 nm, about 50 to about 300 nm, about 50 to about 250 nm, or about 50 to about 200 nm.

19. A process comprising:
comminuting a silicon feed in a solvent and in the presence of an oxide source to form a silicon nanoparticle slurry including silicon nanoparticles coated in silicon-oxide; and
annealing the silicon nanoparticle to crystallize the silicon-oxide.

20. A process comprising:
comminuting a silicon feed in a solvent thereby forming a silicon nanoparticle slurry in the presence of a dry reagent to form a SiX-coated silicon nanoparticle slurry; and
heating the SiX-coated silicon nanoparticle slurry;
wherein the dry reagent comprises an oxide source, a sulfide source, or a carbide source; wherein the SiX-coated silicon nanoparticle slurry includes a SiX-coated silicon nanoparticle in the solvent; wherein the SiX-coated silicon nanoparticle includes a SiX coating on a silicon nanoparticle; and wherein the SiX coating is a silicon-oxide when the dry reagent is an oxide source, a silicon-sulfide when the dry reagent is a sulfide source, or a silicon-carbide when the dry reagent is a carbide source.
